(19) United States
(12) Patent Application Publication
(10) Pub. No.: US 2018/0020794 A1
(43) Pub. Date: Jan. 25, 2018

(54) BAG DESIGNED FOR CHARGING ELECTRONIC DEVICES ON-THE-GO

(71) Applicant: Bindu Rama RAO, Laguna Niguel, CA (US)

(72) Inventor: Bindu Rama RAO, Laguna Niguel, CA (US)

(21) Appl. No.: 15/293,288

(22) Filed: Oct. 14, 2016

Related U.S. Application Data
(63) Continuation-in-part of application No. 15/216,696, filed on Jul. 22, 2016.

(51) Int. Cl. A45C 15/00; H02J 7/00; A45C 5/02; A45F 3/04; A45C 13/02; A45C 11/18

(52) U.S. Cl. CPC A45C 15/00; A45C 13/02; A45C 11/182; A45C 5/02; A45F 3/04; H02J 7/0027; H02J 7/0044; A45C 2011/186; A45C 2011/002

(57) ABSTRACT

A bag to be used for travelling, designed for convenience. It holds a traveler's items, including a mobile phone, tablets and camera. It helps store the traveler's items safely, conveniently and also helps charge them on-the-go. It is made of strong material to provide slash resistance, durability and ease of mind during travel.

### CROSS REFERENCES TO RELATED APPLICATIONS

The present patent application is a continuation-in-part (CIP) of, claims priority to, and makes reference to United States non-provisional patent, Ser. No. 15/216,696 filed on 22 Jul. 2016, entitled “BAG FOR HOLDING TRAVEL ITEMS, DESIGNED FOR CONVENIENCE”, docket number SEKURT-01. The complete subject matter of the above-referenced United States patent application is hereby incorporated herein by reference in its entirety.

### BACKGROUND

### 1. Technical Field

The present invention relates generally to bags used to carry items for travel, and specifically to strong bags that can also safely and conveniently store user's electrical devices.

### 2. Related Art

People have been travelling for ages. Travel for fun or for business has become a common activity. People of late have been carrying mobile phones with them, often taking their mobile phone chargers with them. Similarly, most travellers carry cameras and camcorders with them on their journey, and they pack additional chargers for those cameras and camcorders. When a person travels abroad, that person often takes power adapters with them, and quite often several different power adapters, one for each electrical device, such as the mobile phone, the camera, the hair dryer, etc. These plethora of chargers, cables, power adapters, one for each electrical device packed by the traveller, add to the complexity of packing for a trip, and add to the total luggage weight.

Often, a traveller unpacks all his electrical devices at the end of a day of travel, and back at the hotel, in order to charge them for the next day of use. This involves locating several different power outlets, one for each electrical device to be charged, and then bringing out the charging cables, hooking them up to the electrical devices, and plugging the other end of the charging cables into power adapters (as necessary) before plugging the power adapters into wall sockets. This rigmarole is repeated in reverse order the next day in the morning to repack all those cables, the plurality of power adapters, the wall sockets, and the devices. Often a traveller forgets to repack some of those cables, power adapters and devices, only to realize much later that those items have been left behind at the hotel.

Pickpocketing is a problem in quite a few places where people tend to visit. Pickpockets can be found in several cities and even in rural places all over the world, and losses due to theft are quite devastating to some travellers. For example, a pickpocket may cut open a traveller's bag and steal a purse full of cash and credit cards without the traveller discovering the loss much later. Thieves have been known to slash bags even without the traveller noticing such activities, or realizing that her belongings are being stolen.

There is a need for better bags that are more secure, and more convenient. There is a need for bags that provide the user the ability to easily handle unpacking and repacking at hotels.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a luggage bag for travel items defining a storage volume, wherein the luggage bag comprises a plurality of walls, wherein those of the plurality of walls constituting the outer walls comprise a slash resistant material layer;

FIG. 2 is a perspective block diagram of another bag for travel items;

FIG. 3 is a perspective block diagram of a multi-pocket travel bag, comprising a first bag region comprising first and second opposing sidewalls, joined together along a first side edge, an opposite second side edge, and a bottom edge, the first second sidewalls being un-joined along at least a portion of their respective top edges to define an opening;

FIG. 4 is a perspective block diagram of a bag that comprises a powerbank charger, a slot to enable connection of the powerbank charger to a power socket on a wall via a power charging cable to be connected to the powerbank charger, and a plurality of pouches for securely housing electronic devices, wherein the pouches are organized in proximity to the powerbank charger;

FIG. 5 is a sturdy bag designed for carrying articles, the sturdy bag comprising straps that is worn over shoulders or across the chest, the sturdy bag also comprising a powerbank charger that charges a plurality of electronic devices among the articles in the sturdy bag that are electrically connected to the powerbank charger; and

FIG. 6 is a perspective block diagram of a bag to carry items, wherein the items comprises a tablet, a mobile phone and a camera, the bag comprising a first region of the bag with a camera pouch to hold a camera, a mobile phone pouch to hold a mobile phone, and a tablet pouch to hold a tablet, wherein the tablet pouch and the mobile phone pouch are positioned across from each other.

### DETAILED DESCRIPTION OF THE DRAWINGS

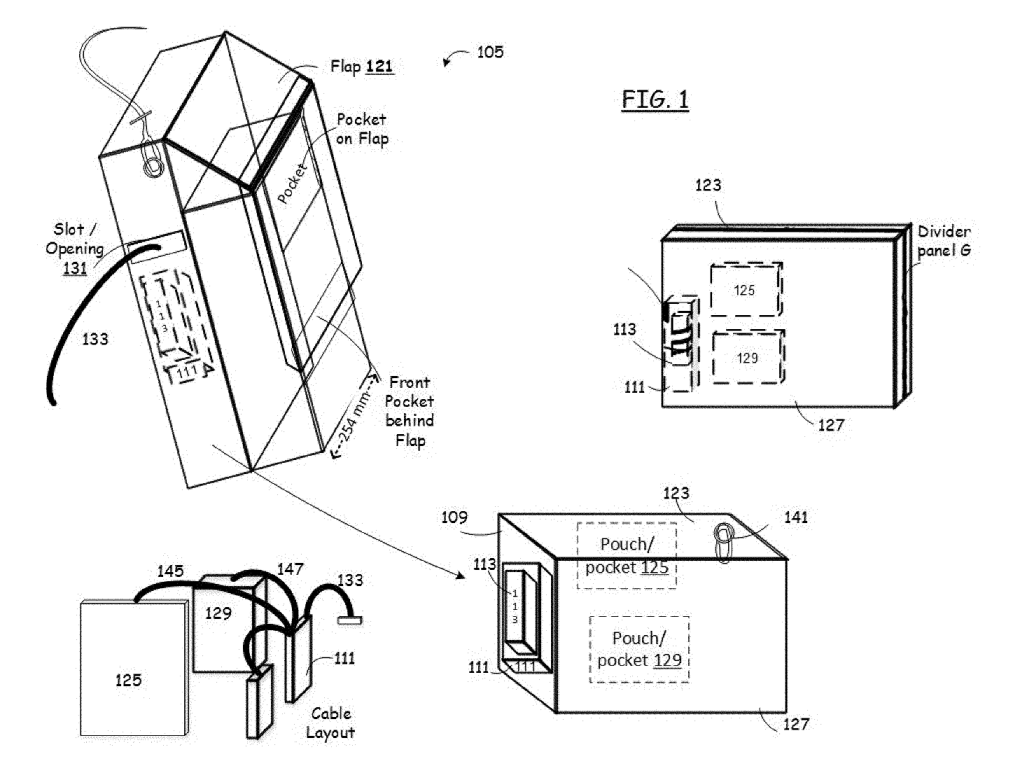

FIG. 1 is a perspective block diagram of a luggage bag for travel items defining a storage volume, wherein the luggage bag 105 comprises a plurality of walls, wherein those of the plurality of walls constituting the outer walls 121 comprise a slash resistant material layer 107. Thus, the items inside the luggage bag 105 is not easy to steal by pickpockets and thieves who often try to silently make a cut or tear in the bag without the traveller/user noticing it. The luggage bag 105 also comprises a first wall 109 among the plurality of walls along which a first holder 111 for a powerbank portable charging device 113 is provided, wherein the powerbank portable charging device 113 supplies power from its built-in batteries through a plurality of USB ports (for example).

The luggage bag 105 also comprises a second wall 123 among the plurality of walls along which a second holder 125 for a mobile device is provided, and a third wall 127 among the plurality of walls wherein a third holder 129 for a camera is provided. The second holder 125 and third holder 129 are in proximity to the first holder 111, in a configuration that minimizes the distance between them. For example, second holder 125 and third holder 129 are each within 2 inches of the first holder 111, in one configuration, making them close enough to connect to their respective devices (that are housed in those holders) to the powerbank portable charging device 113 employing a very short power cable, such as a USB power cable, of about 3 inches or so. The very short power cables are attached to the corresponding walls, in a related embodiment, using glue or stitches.

The luggage bag 105 also comprises a USB outlet 131 on one of the walls constituting the outer walls for a power cable connection to the powerbank portable charging device 113 located in the first holder 111. The USB outlet 131 makes it possible to pass a USB power charging cable 133 out of the bag towards a USB based power outlet, for providing power to the powerbank portable charging device 113.

In one configuration, the luggage bag 105 also comprises a pocket for credit cards 141, to hold a plurality of credit cards. The pocket in a related embodiment comprises a plurality of slots for credit cards, for housing each credit in its own slot inside the pocket.

In a related embodiment, the pocket for credit cards comprises walls with an electromagnetic field (EMF) blocking material layer. In another embodiment, the pocket is large enough to house not only credit cards but also small electronic devices, such as a small mobile phone.

In one configuration, the slash resistant material layer of the luggage bag 105 is secured to corresponding ones of the plurality of outer walls constituting the outer walls, by stitches. In another related configuration, the slash resistant material layer of the luggage bag 105 is secured by glue or staples. Other forms of attaching the slash resistant material layer, such as Kevlar or Nomax aramids for example, are also contemplated.

In one configuration of the luggage bag 105, a first USB power charging cable 145 leading from the first holder 111 to the second holder 125, and a second USB power charging cable 147 leading from the first holder 111 to the third holder 129, are provided. In a related configuration, the first USB power charging cable 145 and the second USB power charging cable 147 are both physically attached to the associated ones of the plurality of outer walls.

In one embodiment, the holders 111, 125, 129 are elastic bands that help secure devices. In another embodiment, the holders 111, 125, 129 are pockets, and in another related embodiment, the holders 111, 125, 129 are pockets with zippers that securely house any electrical or non-electrical devices placed inside.

The luggage bag 105 now makes it possible to
Charge electrical devices on the go, as they are securely housed in pockets in the bag and the powerbank portable charging device provides recharge capabilities even when mobile (in trains, planes, running etc.)
Security and safety provided—Slash resistant bags which pickpockets and thieves will find very hard to slash, cut, etc. to steal items inside
RFID and credit card safe—EMF protection to make sure identity thieves and credit card thieves do not get hold of digital data in credit cards, passports and identity cards
In addition, in some embodiments, the pockets are made of anti-bacterial and anti-microbial material, such that bacteria, mold and fungus does not grow in pockets, even in places where humidity is relatively high.

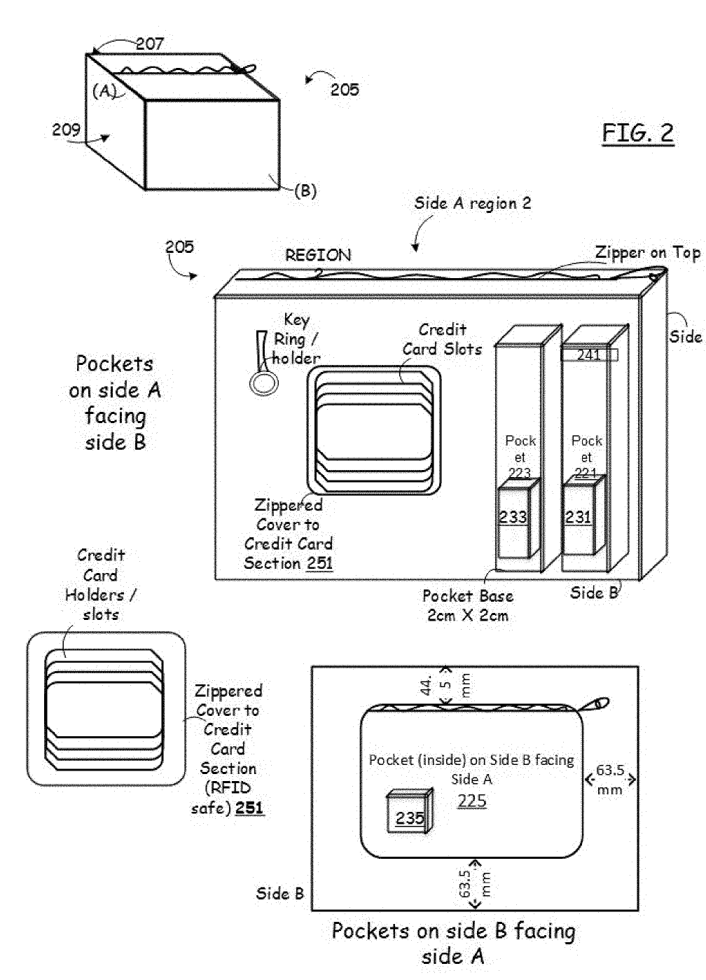

FIG. 2 is a perspective block diagram of another bag 205 for travel items. The bag 205 comprises a body 207 comprising at least one openable and closable surface, wherein the body is surrounding at least one interior compartment 209 with means to gain access to the at least one interior compartment, the at least one interior compartment 209 having sufficient length to house a powerbank portable charging device, a mobile phone, and a camera. FIG. 2 also depicts not only a perspective diagram of the bag 205, but also views for component walls A and B, with examplary pockets associated on those component walls A & B. Specifically, it shows pockets on Side A of the interior compartment 209, and pockets on side B of the interior compartment 209 facing side A.

The bag 205 comprises at least a first carrying pocket 223 for the mobile phone, a second carrying pocket 225 for the camera and an additional carrying pocket 221 for the powerbank portable charging device. It is important to note that the dimensions shown in the figures for various pockets and various components of the bag are only exemplary and the bag is configured differently (with possibly different dimensions/sizes) for specific embodiments.

The bag 205 simultaneously houses the powerbank portable charging device 231, the mobile phone 233 and the camera 235 in corresponding pockets, while the powerbank portable charging device 231 charges both the mobile phone 233 and the camera 235 simultaneously. The bag 205 provides a charging cable slot 241 through which a first charging cable passes, the powerbank portable charging device 231 is connected to the first charging cable and to an external power outlet employing the first charging cable that travels through the charging cable slot. The bag 205 is configured such that the first charging cable connects the powerbank portable charging device 231 to the external power outlet, so that the bag simultaneously houses the powerbank portable charging device 231, the mobile phone 233 and the camera 235 even as the powerbank portable charging device 231 is charged by the external power outlet and the mobile phone 233 and the camera 235 are at the same time charged by the powerbank portable charging device 231.

In one configuration, the bag 205 is configured to simultaneously house the mobile phone 233 and the camera 235 in corresponding pockets 223, 225, with the powerbank portable charging device 231 electrically connected to an external power outlet, while the powerbank portable charging device 231 charges both the mobile phone 233 and the camera 235 simultaneously. In a related embodiment, additional electrical devices, housed in additional pockets, are also charged by the powerbank portable charging device 231.

The bag 205 comprises a slash resistant fabric covering the body, wherein the slash resistant fabric resists horizontal, vertical and diagonal slashes made from a slashing device. In one related configuration, the slash resistant fabric comprises one or more layers of Kevlar based fabrics. In another configuration, the slash resistant fabric comprises one or more layers of Kevlar fabric strips that are woven into a mat and serves as a strong slash resistant single layer of fabric.

The bag 205 also comprises an electromagnetic field (EMF) 251 blocking pocket configured to hold a plurality of credit cards.

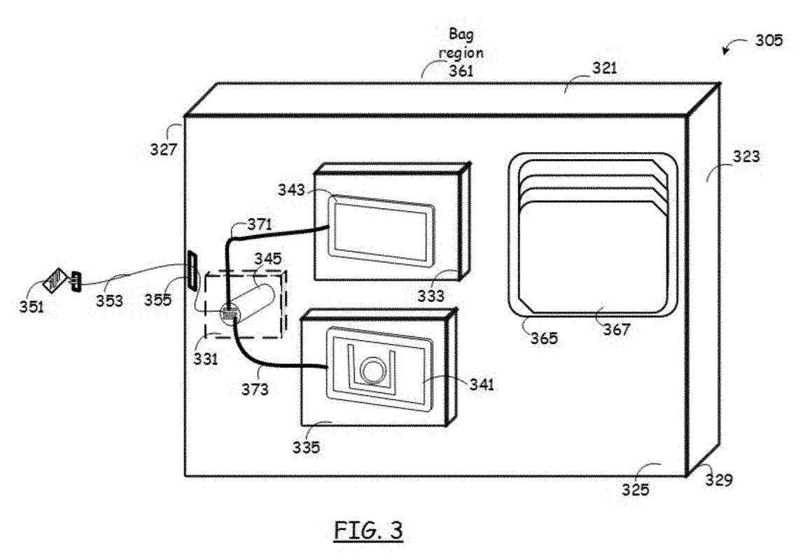

FIG. 3 is a perspective block diagram of a multi-pocket travel bag 305, comprising a first bag region 361 comprising first and second opposing sidewalls 321, 325 joined together along a first side edge 327, an opposite second side edge 323, and a bottom edge 329, the first 321 and second 325 sidewalls being un-joined along at least a portion of their respective top edges to define an opening. The multi-pocket travel bag 305 also comprises a first pocket 331 along the first edge 327 for storing a powerbank charging device 345, and a second pocket 333 along the first sidewall 321 in relative proximity to the first pocket 331, wherein the second pocket 333 is configured to hold a mobile device 343. It also comprises a third pocket 335 along the second sidewall 325 in relative proximity to the first pocket 331, wherein the third pocket 335 is configured to hold one of a camera 341 and a camcorder, and a card holding detachable inner bag 365 positioned within the first bag region 361, the card holding detachable inner bag 365 configured to hold a plurality of credit cards and identity cards, the card holding detachable inner bag comprising a zippered opening section at the top, and walls made with EMF blocking material. The card holding detachable inner bag 365 comprises slots 367 to hold the credit cards and identity cards, one card per slot.

In one configuration, multi-pocket travel bag 305 further comprises slash resistant capabilities—the first 321 and second 325 opposing sidewalls each comprising a layer of slash resistant fabric. In another related configuration, the layer of slash resistant fabric comprises one or more layers of Kevlar-based fabric. In yet another configuration, layer of slash resistant fabric comprises one or more of a Nomax aramid fabric, a nylon based fabric, a denier based fabric, or a combination thereof.

The multi-pocket travel bag 305 comprises, in one configuration, a cable entry slot 355 close to the first pocket 331 and the first edge 327 for passing a cable 353 from an external power outlet 351 or device to the powerbank charging device 345.

The multi-pocket travel bag 305, in another configuration, is configured to simultaneously hold in their respective pockets 331, 333, 335 the powerbank charging device 345, the mobile device 343 and the camera or camcorder 341, even as the powerbank charging device 345 in the first pocket 331 is used to simultaneously charge the mobile device 343 in the second pocket 333 and the camera or camcorder 341 in the third pocket 335.

The multi-pocket travel bag 305, in another configuration, is configured to simultaneously hold in their respective pockets 331, 333, 335 the powerbank charging device 345e, the mobile device 343 and the camera or camcorder 341 even as the powerbank charging device 345 is plugged into a external power outlet 351 or device for charging via a cable 353 passed through the cable entry slot 355, and the mobile device 343 and the camera or camcorder 341 are also at the same time plugged into the powerbank charging device 345 employing appropriate charging cables.

The multi-pocket travel bag 305, in a different configuration, comprises a mobile charging cable 371 positioned along and attached into the first sidewall 321 exposing appropriate sockets at either ends, that enables charging of the mobile device 343 by the powerbank charging device 345. It also comprises a camera or camcorder charging cable 373 positioned along and attached into the second sidewall 325 exposing appropriate sockets at either ends enabling charging of the camera or camcorder 341 by the powerbank charging device 345.

In another configuration of the multi-pocket travel bag 305, the cable entry slot 355 close to the first pocket 331 and the first edge 327 comprises a power charging socket (not shown) to which the powerbank charging device 345 is electrically connected to enable connection to an external power outlet 351 or device employing a power charging cable 353. The power outlet 351 is connected to the power charging socket by means of a charging cable, while the powerbank charging device 345 is electrically connected to the power charging socket inside the bag. In a related configuration, the power charging socket is a USB based socket, to which the powerbank charging device 345 is electrically connected via an appropriate USB cable, to enable connection to an external power outlet 351 or device employing a USB based power charging cable.

In another related embodiment, the multi-pocket travel bag 305 is a backpack, wherein the first sidewall 321 is the front of the backpack, and the second sidewall 325 is the reverse side of the backpack.

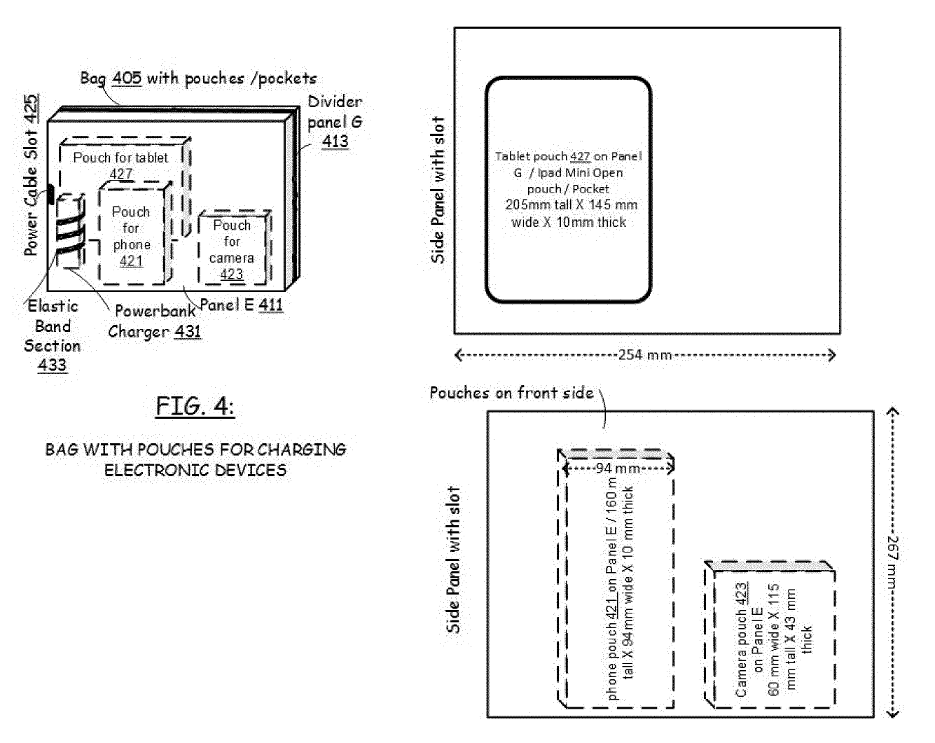

FIG. 4 is a perspective block diagram of a bag 405 that comprises a powerbank charger 431, a slot 425 to enable connection of the powerbank charger 431 to a power socket 661 on a wall via a power charging cable 663 to be connected to the powerbank charger 431, and a plurality of pouches 427, 421, 423 for securely housing electronic devices, wherein the pouches are organized in proximity to the powerbank charger.

The bag 405 comprises rubberized slide-resistant shoulder straps (not shown) that allow it to be carried on one's back or across one's shoulder. The powerbank charger 431 charges the plurality of electronic devices stored in the pouches 427, 421, 423 in the bag. An elastic restraining holder 433 (also called Elastic band section 433) in the bag 405 is configured to hold the powerbank charger 431 as it simultaneously charges those of the plurality of electronic devices that are currently connected to it.

The plurality of pouches 427, 421, 423 are employed to house/to hold the plurality of electronic devices, each of the plurality of pouches is configured inside the bag 405 so as to safely and securely house and narrowly fit a corresponding one of the plurality of electronic devices while it is being charged by the powerbank charger 431.

Each of the plurality of pouches 427, 421, 423 (some times also referred to as pockets in some configurations) is configured to be in proximity to the powerbank charger 431 and is configured to minimize the length of a corresponding charging cable used to electrically charge corresponding ones of the plurality of electronic devices currently housed in it.

In one embodiment, the plurality of electronic devices are housed in their respective pouches in the bag 405, wherein the plurality of electronic devices comprises a mobile phone, a tablet and a camera. For example, a user's mobile phone, such as an APPLE iphone 6, is located in the pouch for phone 421.

A rubberized slot 425 on the bag 405, such as on a side panel of the bag 405, is provided for passing a charging cable 663 that is externally connected to an electrical power socket 661 on a wall at one end, and internally connected to the powerbank charger 431 at the other end.

In one configuration, the bag 405 is a backpack designed for carrying articles on a person's back, wherein the electronic devices among the articles (such as mobile phones, audio players, cameras, tablet devices, etc.) are electrically connected, and are constantly charged on-the-go by the powerbank charger 431. Thus the bag 405 provides “mobility” as well as on-the-go charging capabilities.

In another related configuration, the bag 405 is a travel bag used to carry electronic devices and other belongings when traveling, wherein the electronic devices are electrically connected and constantly charged on-the-go by the powerbank charger 431.

In yet another related configuration, the bag 405 is a messenger bag with one single non-slip strap, wherein the bag is worn over one shoulder with the strap that goes across the chest resting the bag on the hip or lower back.

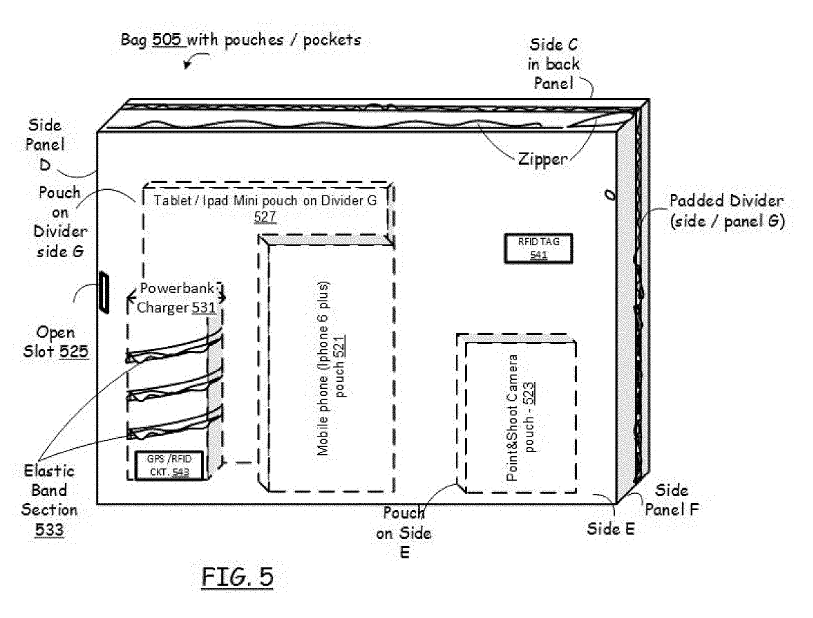

FIG. 5 is a sturdy bag 505 designed for carrying articles, the sturdy bag 505 comprising straps that is worn over shoulders or across the chest, the sturdy bag 505 also comprising a powerbank charger 531 that charges a plurality of electronic devices among the articles in the sturdy bag 505 that are electrically connected to the powerbank charger 531. The sturdy bag 505 provides a pouch or a pocket or an elastic band section 533 to house the powerbank charger 4 531, wherein the pouch 533 is configured to properly and exactly fit the powerbank charger 431 while simultaneously exposing the ports of the powerbank charger 531 such that the powerbank charger 531 is connectable to the plurality of electronic devices via appropriate charging cables.

A rubberized slot 525 on one side or panel of the bag, close to the powerbank charger 531 is provided for passing a charging cable 663 that is externally connected to an electrical power socket 661 on a wall at one end, and internally connected to the powerbank charger 531 at the other end.

In a related embodiment, a plurality of pouches 527, 521, 523 provided in the sturdy bag 505 are configured to be in proximity to the pouch or elastic band section 533 housing the powerbank charger 531 and configured to minimize the length of a corresponding charging cable used to electrically charge corresponding ones of the plurality of electronic devices currently housed in the plurality of pouches 527, 521, 523.

In another related embodiment, a plurality of pouches 527, 521, 523 provided in the bag 505 are configured such that the overall thickness of the bag 505 is minimized even when each of the plurality of pouches 527, 521, 523 is used to house corresponding ones of the plurality of electronic devices. For example, the camera pouch 523 used to store a point and shoot camera is situated to the right of both the mobile phone pouch 521 and the tablet/ipad pouch 527, so that the overall thickness of the region/section of the sturdy bag 505 is minimum, the camera often being more bulkier and fatter (in terms of its depth or thickness) than the tablet and the mobile phone. In fact, quite often, the combined thickness of the tablet and the mobile phone is less than the thickness of the camera. Thus the placement/location of the pouch in the panels of the sturdy bag 505 matters to determine the overall thickness of the sturdy bag 505.

In a related configuration, the plurality of pouches 527, 521, 523, in one of multiple regions of the bag, are each configured such that the overall thickness of that region of the bag is minimized even when each of the plurality of pouches 527, 521, 523 is used to house corresponding ones of the plurality of electronic devices.

In one configuration, the pouch 533 configured to house the powerbank charger 531 is a set of elastic bands with an open separation space in between the elastic bands of the set, wherein the set of elastic bands are configured to hold the powerbank charger 531 while also exposing the ports of the powerbank charger so that they can be connected to the plurality of electronic devices via appropriate charging cables.

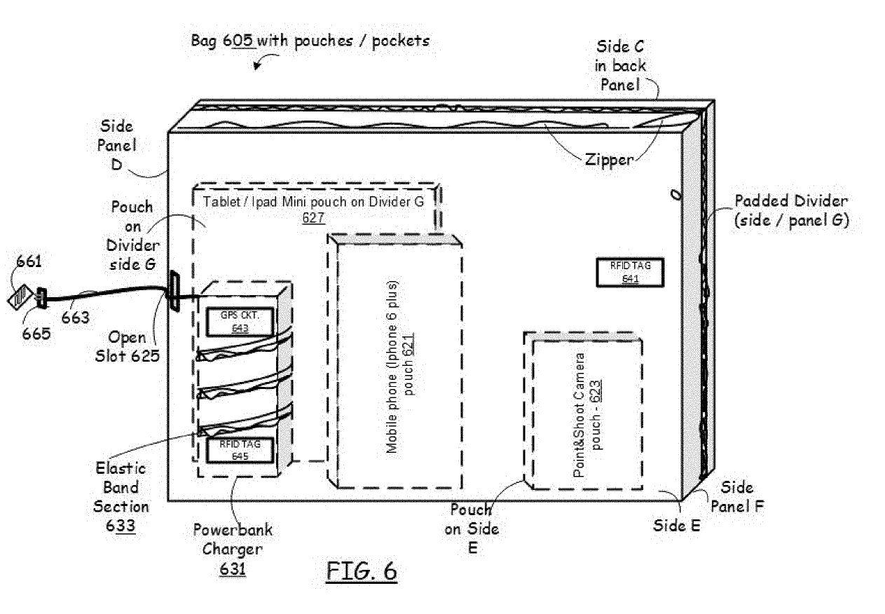

FIG. 6 is a perspective block diagram of a bag 605 to carry items, wherein the items comprises a tablet, a mobile phone and a camera, the bag 605 comprising a first region of the bag with a camera pouch 623 to hold a camera, a mobile phone pouch 621 to hold a mobile phone, and a tablet pouch 627 to hold a tablet, wherein the tablet pouch 627 and the mobile phone pouch 621 are positioned across from each other. The bag 605 also comprises a powerbank charger 631 holder configured to hold a powerbank charger 631 in such a way that it exposes the plurality of ports of the powerbank charger 631 and enables power charging cable connections via those plurality of ports. The powerbank charger 631 provides electrical power to the tablet, the mobile phone and the camera via the plurality of ports of the powerbank charger, when those devices are connected to the powerbank charger 631 via charging cables appropriate to those devices. The term powerbank as used here includes portable rechargeable charging devices that perform pass-thru charging of electronic devices. The powerbank charger 631 supports a feature known as passthrough charging. This allows the powerbank charger 631 to function as a USB hub of sorts, wherein a user can simultaneously charge both the powerbank charger 631 itself and other electronic devices/mobile devices connected to it (by charging cables), and ensures the powerbank charger 631 is always topped up and ready to go when the user needs it.

The camera pouch 623 is positioned such that it does not overlap with the mobile phone pouch 621 or the tablet pouch 627, and the overall thickness of the first region is minimized. The bag 605 in one configuration also comprises a second region of the bag that provides a second mobile phone pouch to hold a second mobile phone, and a third region that provides an EMF protected credit cards holder pocket 251, to hold credit cards securely with EMF protection.

In one configuration, the powerbank charger holder 633 (also referred to as the elastic band section 633 sometimes) comprises a set of elastic bands arranged to form an expandable space, wherein the powerbank charger holder exposes the ports of the powerbank charger 631 even as it is housed within the expandable space, for connecting to the mobile phone, the camera and the tablet.

A power cable outlet 625 (also called open slot 625) provided on the outside of the bag 605 (in a side panel, for example), configured close to the powerbank charger holder 633, for passing a power charging cable 663 attached to a power source 661 outside the bag 605 while it is also connected to the powerbank charger 631 inside the bag 605. The bag 605 comprises power cables that, when connected to the ports of the powerbank charger 631 at one end, and to the mobile phone, camera or tablet at the other end, provides electrical power for charging, or for operating purposes.

The bag also comprises an RFID chip tag 641 that receives, stores and transmits digital information in multiple frequencies, wherein the RFID chip tag 641 comprises a unique ID number. The RFID chip 641 tag responds to interrogation by the mobile phone in the mobile phone pouch of the bag, by providing at least the unique ID number that is used for tracking the bag via the mobile phone or by a remote server communicatively coupled by the mobile phone.

In one configuration, the powerbank charger 631 in the bag 605 comprises a GPS circuitry 643 and an RFID tag circuitry 645 and communicates the unique ID number and GPS coordinates to the mobile phone in the mobile phone pouch periodically and when requested by the mobile phone.

In one configuration, the powerbank charger 631 in the bag copies and stores for backup and sharing, photos and videos from the connected mobile phone, photos and videos from the connected camera, and photos and videos from the connected tablet. For example, the powerbank charger 631 comprises memory, storage and communication circuitry that enables it to receive and store all photos and videos transferred/communicated by the mobile phone, tablet (APPLE ipad, etc.), and camera that it is currently connected to. It is capable of sharing such transferred photos and videos with websites, video servers, social groups, social networks, YouTUBE network, Facebook network, etc. It is capable of uploading transferred photos and videos with Google websites, Google photos network, etc. The devices (camera, mobile phone, tablet, etc.) can then automatically delete those transferred photos and videos thereby making more memory/storage available for additional photos, data, videos, etc.

In a related embodiment, the powerbank charger 631 has a USB memory stick/storage plugged into one of its output ports, and the powerbank charger stores (automatically or when requested by user, based on configuration settings, preferences, etc.) photos and videos received from other plugged electronic devices (mobile phone, camera, tablet, etc.) in the USB memory stick/storage plugged in—as a way to backup all those photos and videos so as to release storage/memory used in those electronic devices for other usage/purposes.

As one of ordinary skill in the art will appreciate, the terms “bag” and “travel bag,” as may be used herein, include bags used by a person, to carry during travel a collection of things to wear and personal devices to use, or a collection electrical devices to conduct one's business with. The term powerbank as used here includes portable and rechargeable battery packs (portability: some of the power banks are small and light enough to slip into a pocket) that come in all shapes, weights and capacities, from emergency credit-card-sized charging devices that offers a quick boost to a user's mobile phone to keep the user going until the user get's home, to the ultra-high-capacity chargers, which might charge one's phone in excess of 10 times that are ideal if one is going camping or has several devices to charge. For example, a powerbank charger may comprise one or more inputs and one or more output ports. It may comprise a 2A (10 W) input or a 1A (5 W) input, and a mobile phone that is charged by them supports 1A (5 W) input or a 2A (10 W) output. The term powerbank charger as used herein includes rechargeable lithium-ion battery units, that comprise two or more USB ports for charging electronic devices, that are compatible with mobile phones, MP3 or MP4 devices, and digital cameras that employ Micro USB cable as a power charging cable.

As one of ordinary skill in the art will appreciate, the terms “cable” includes USB cables used to charge electronic devices, micro-USB cables, lightening cables, cables used to charge APPLE iphones, APPLE ipads, and other tablets, micro-USB cables used to charge digital cameras and camcorders, etc.

As one of ordinary skill in the art will appreciate, the terms “connected” and “electrically connected,” as may be used herein, include direct coupling and indirect coupling via another component, element, circuit, or module where, for indirect coupling, the intervening component, element, circuit, or module does not modify the charging function but may adjust its current level, voltage level, and/or power level.

As one of ordinary skill in the art will appreciate, the terms “narrowly fit” used for pouches includes a proper fit determined according to the known size of the devices to be stored in the respective pouches/pockets. Cameras and mobile phones have different sizes/dimensions, and their respective pouches need to be properly dimensioned to hold them relatively tightly, or appropriately, so that they are securely and safely housed, without getting jostled in loose pouches.

Although the present invention has been described in terms of USB based power charging of devices, other forms and techniques to charge electrical devices such as mobile phones and cameras are also contemplated.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A bag with shoulder straps that allow it to be carried on one's back or across one's shoulder, the bag comprising:
a powerbank charger for charging a plurality of electronic devices stored in the bag;
an elastic restraining holder configured to hold the powerbank charger as it simultaneously charges those of the plurality of electronic devices that are currently connected.

2. The bag of claim 1 further comprising:
a plurality of pouches to hold the plurality of electronic devices, each of the plurality of pouches configured inside the bag so as to safely and securely house, and narrowly fit, a corresponding one of the plurality of electronic devices while it is being charged by the powerbank charger.

3. The bag of claim 1 further comprising:
a plurality of pouches to house the plurality of electronic devices, each of the plurality of pouches configured to be in proximity to the powerbank charger and configured to minimize the length of a corresponding charging cable used to electrically charge corresponding ones of the plurality of electronic devices currently housed in it.

4. The bag of claim 1 wherein the plurality of electronic devices housed in their respective pouches comprises a mobile phone, an electronic tablet device and a digital camera.

5. The bag of claim 1 further comprising:
a rubberized slot for passing a charging cable that is externally connected to an electrical power socket on a wall at one end, and internally connected to the powerbank charger at the other end.

6. The bag of claim 1 wherein the bag is a backpack designed for carrying articles on a person's back, wherein the electronic devices among the articles are electrically connected, and are constantly charged on-the-go by the powerbank charger.

7. The bag of claim 1 wherein the bag is a travel bag used to carry electronic devices and other belongings when traveling, wherein the electronic devices are electrically connected and constantly charged on-the-go by the powerbank charger.

8. The bag of claim 1 wherein the bag is a messenger bag with one single strap, wherein the bag is worn over one shoulder with the strap that goes across the chest resting the bag on the hip or lower back.

9. A sturdy bag designed for carrying articles, the sturdy bag comprising straps that is worn over shoulders or across the chest, the sturdy bag comprising:
a powerbank charger that charges a plurality of electronic devices among the articles in the sturdy bag that are electrically connected to the powerbank charger;
a pouch to house the powerbank charger, configured to properly and exactly fit the powerbank charger while simultaneously exposing the ports of the powerbank charger such that the powerbank charger is connectable to the plurality of electronic devices via appropriate charging cables.

10. The sturdy bag of claim 9 further comprising:
a rubberized slot for passing a charging cable that is externally connected to an electrical power socket on a wall at one end, and internally connected to the powerbank charger at the other end.

11. The sturdy bag of claim 9 further comprising:
a plurality of pouches configured to be in proximity to the pouch housing the powerbank charger and configured to minimize the length of a corresponding charging cable used to electrically charge corresponding ones of the plurality of electronic devices currently housed in the plurality of pouches.

12. The sturdy bag of claim 9 further comprising:
a plurality of pouches that are configured such that the overall thickness of the bag is minimized even when each of the plurality of pouches is used to house corresponding ones of the plurality of electronic devices.

13. The sturdy bag of claim 9 further comprising:
a plurality of pouches, in one of multiple regions of the bag, that are each configured such that the overall thickness of that region of the bag is minimized even when each of the plurality of pouches is used to house corresponding ones of the plurality of electronic devices.

14. The sturdy bag of claim 9 further comprising:
the pouch to house the powerbank charger is a set of elastic bands with an open separation space in between the elastic bands of the set, wherein the set of elastic bands are configured to hold the powerbank charger while also exposing the ports of the powerbank charger so that they can be connected to the plurality of electronic devices via appropriate charging cables.

15. A bag to carry items, wherein the items comprises a tablet, a mobile phone and a camera, the bag comprising:
a first region of the bag with a camera pouch to hold a camera, a mobile phone pouch to hold a mobile phone, and a tablet pouch to hold a tablet, wherein the tablet pouch and the mobile phone pouch are positioned across from each other;
a powerbank charger holder configured to hold a powerbank charger in such a way that it exposes the plurality of ports of the powerbank charger and enables power charging cable connections via those plurality of ports; and
the powerbank charger that provides electrical power to the tablet, the mobile phone and the camera via the plurality of ports of the powerbank charger.

16. The bag of claim 15 wherein the camera pouch is positioned such that it does not overlap with the mobile phone pouch or the tablet pouch, and the overall thickness of the first region is minimized.

17. The bag of claim 15 wherein the bag comprises a second region of the bag that provides a second mobile phone pouch to hold a second mobile phone, and a third region that provides an EMF protected credit cards holder pocket, to hold credit cards securely with EMF protection.

18. The bag of claim 15 further comprising:
the powerbank charger holder comprises a set of elastic bands arranged to form an expandable space, wherein the powerbank charger holder exposes the ports of the powerbank charger even as it is housed within the expandable space, for connecting to the mobile phone, the camera and the tablet;
a power cable outlet on the outside of the bag, configured close to the powerbank charger holder, for passing a power charging cable attached to a power source outside the bag while it is also connected to the powerbank charger inside the bag; and
the bag comprises power cables that, when connected to the ports of the powerbank charger at one end, and to the mobile phone, camera or tablet at the other end, provides electrical power for charging, or for operating purposes.

19. The bag of claim 15 further comprising:
an RFID chip tag that receives, stores and transmits digital information in multiple frequencies, wherein the RFID chip tag comprises a unique ID number; and
the RFID chip tag responds to interrogation by the mobile phone in the mobile phone pouch of the bag, by providing at least the unique ID number that is used for tracking the bag via the mobile phone or by a remote server communicatively coupled by the mobile phone.

20. The bag of claim 15 further comprising:
the powerbank charger in the bag comprises a GPS circuitry and an RFID tag circuitry and communicates the unique ID number and GPS coordinates to the mobile phone in the mobile phone pouch periodically and when requested by the mobile phone; and
the powerbank charger in the bag copies and stores for backup and sharing photos and videos from the connected mobile phone, photos and videos from the connected camera, and photos and videos from the connected tablet.
